(19) United States
(12) Patent Application Publication
(10) Pub. No.: US 2012/0037241 A1
(43) Pub. Date: Feb. 16, 2012

(54) Multi-port shuttle valve method

(76) Inventor: Benton F. Baugh, Houston, TX (US)

(21) Appl. No.: 12/806,448

(22) Filed: Aug. 13, 2010

(51) Int. Cl. F16K 51/00

(52) U.S. Cl. 137/15.18

(57) ABSTRACT

The method of providing a shuttle valve which will accept 3 or more inputs, comprising providing a body having a bore and an outlet, providing two or more shuttles within the bore, providing an inlet in the body between each of the shuttles, and causing flow from an inlet to move the shuttles to positions appropriate to allow flow from the inlet into the shuttle valve and blocking flow out of the other of the inlets.

### TECHNICAL FIELD

This invention relates to the method of shuttling fluid from more than 2 input ports to a single outlet for the control of functions, especially in deep water.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

Subsea drilling control systems as used on subsea blowout preventer stacks have conventionally had two redundant control systems—a blue system and a yellow system. The systems are completely redundant down to the point of a shuttle valve which accepts flow from either of the control systems and delivers it to the function to be controlled. The shuttle valve becomes a single point of failure of the system as when it fails, the system is completely disabled.

There has been some limited additional control by either an acoustically controlled system or a hydraulic connection called a “hot stab” from a remotely operated vehicle or an ROV. If either of these devices are used, a second shuttle valve must be introduced into the system with an additional fail point.

With the new safety requirements, there will be a trend to having both an acoustically controlled backup system and an ROV controlled backup system. This leads to tripling in the number of required shuttle valves as well as a considerable complication to the plumbing, which is already complex.

### BRIEF SUMMARY OF THE INVENTION

The object of this invention is to provide a single shuttle valve which can receive more than 2 inputs.

A second object of this invention is to provide a shuttle valve which can have as many inputs as desired.

A third objective of the present invention is to simplify the plumbing required to deal with multiple input signals to a single outlet.

Another objective of this present invention is to provide rotational flexibility on installation but rigid after installation.

### BRIEF DESCRIPTION OF THE DRAWINGS

FIG. 1 is a view of a deepwater drilling system which would use the shuttle valve of this invention.

FIG. 2 is a graphical representation of the blowout preventer of FIG. 1 showing the blue control pod, the yellow control pod, and the typical shuttle valve arrangement for receiving control from 2 locations.

FIG. 3 is the graphical representation of FIG. 2 showing the complication of the plumbing when additional inputs from 2 other sources is desired.

FIG. 4 is the graphical representation of FIG. 2 showing the shuttle valve of the present invention illustrating how many fewer connections are required.

FIG. 5 is a cross section of the shuttle valve of the present invention showing fluid being input into or received out of a port.

FIG. 6 is a cross section of the shuttle valve of the present invention showing fluid being input into or received out of a different port.

### DETAILED DESCRIPTION OF THE INVENTION

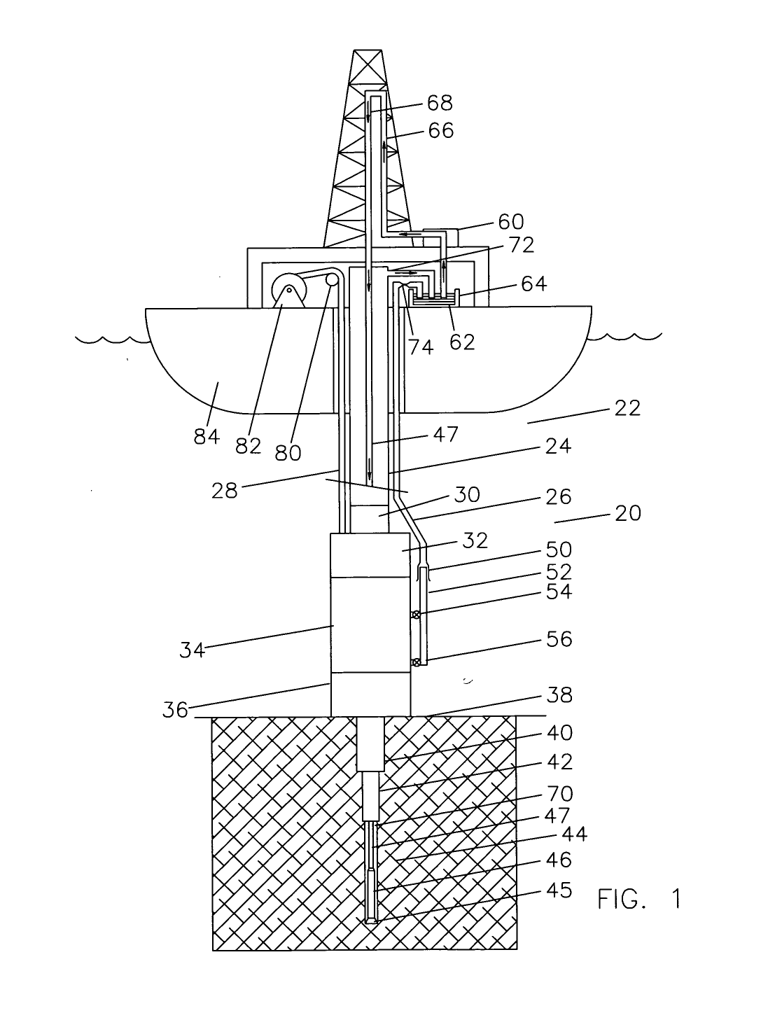

Referring now to FIG. 1, a view of a complete system for drilling subsea wells 20 is shown in order to illustrate the utility of the present invention. The drilling riser 22 is shown with a central pipe 24, outside fluid lines 26, and control lines 28.

Below the drilling riser 22 is a flex joint 30, lower marine riser package 32, lower blowout preventer stack 34 and wellhead 36 landed on the seafloor 38.

Below the wellhead 36, it can be seen that a hole was drilled for a first casing string, that string 40 was landed and cemented in place, a hole drilled through the first string for a second string, the second string 42 cemented in place, and a hole is being drilled for a third casing string by drill string 44 which includes drill bit 45, heavy weight drill collars 46, and lighter weight drill pipe 47.

The lower Blowout Preventer stack 34 generally comprises a lower hydraulic connector for connecting to the subsea wellhead system 36, usually 4 or 5 ram style Blowout Preventers, an annular preventer, and an upper mandrel for connection by the connector on the lower marine riser package 32.

Below outside fluid line 26 is a choke and kill (C&K) connector 50 and a pipe 52 which is generally illustrative of a choke or kill line. Pipe 52 goes down to valves 54 and 56 which provide flow to or from the central bore of the blowout preventer stack as may be appropriate from time to time. Typically a kill line will enter the bore of the Blowout Preventers below the lowest ram and has the general function of pumping heavy fluid to the well to overburden the pressure in the bore or to “kill” the pressure. The general implication of this is that the heavier mud will not be circulated, but rather forced into the formations. A choke line will typically enter the well bore above the lowest ram and is generally intended to allow circulation to circulate heavier mud into the well to regain pressure control of the well.

Normal drilling circulation is the mud pumps 60 taking drilling mud 62 from tank 64. The drilling mud will be pumped up a standpipe 66 and down the upper end 68 of the drill pipe 47. It will be pumped down the drill pipe 47, out the drill bit 45, and return up the annular area 70 between the outside of the drill pipe 47 and the bore of the hole being drilled, up the bore of the casing 42, through the subsea wellhead system 36, the lower blowout preventer stack 34, the lower marine riser package 32, up the drilling riser 24, out a bell nipple 72 and back into the mud tank 64.

During situations in which an abnormally high pressure from the formation has entered the well bore, the thin walled central pipe 24 is typically not able to withstand the pressures involved. Rather than making the wall thickness of the relatively large bore drilling riser thick enough to withstand the pressure, the flow is diverted to a choke line 26. It is more economic to have a relatively thick wall in a small pipe to withstand the higher pressures than to have the proportionately thick wall in the larger riser pipe.

When higher pressures are to be contained, one of the annular or ram Blowout Preventers are closed around the drill pipe and the flow coming up the annular area around the drill pipe is diverted out through choke valve 54 into the pipe 52. The flow passes up through C&K connector 50, up pipe 26 which is attached to the outer diameter of the riser 24, through choking means illustrated at 74, and back into the mud tanks 64.

On the opposite side of the drilling riser 24 is shown a cable or hose 28 coming across a sheave 80 from a reel 82 on the vessel 84. The cable 28 is shown characteristically entering the top of the lower marine riser package 32. These cables typically carry hydraulic, electrical, multiplex electrical, or fiber optic signals. Typically there are at least two of these systems, which are characteristically painted yellow and blue. As the cables or hoses 28 enter the top of the lower marine riser package 32, they typically enter the top of the control pod to deliver their supply or signals. When hydraulic supply is delivered, a series of accumulators are located on the lower marine riser package 32 or the lower Blowout Preventer stack 34 to store hydraulic fluid under pressure until needed.

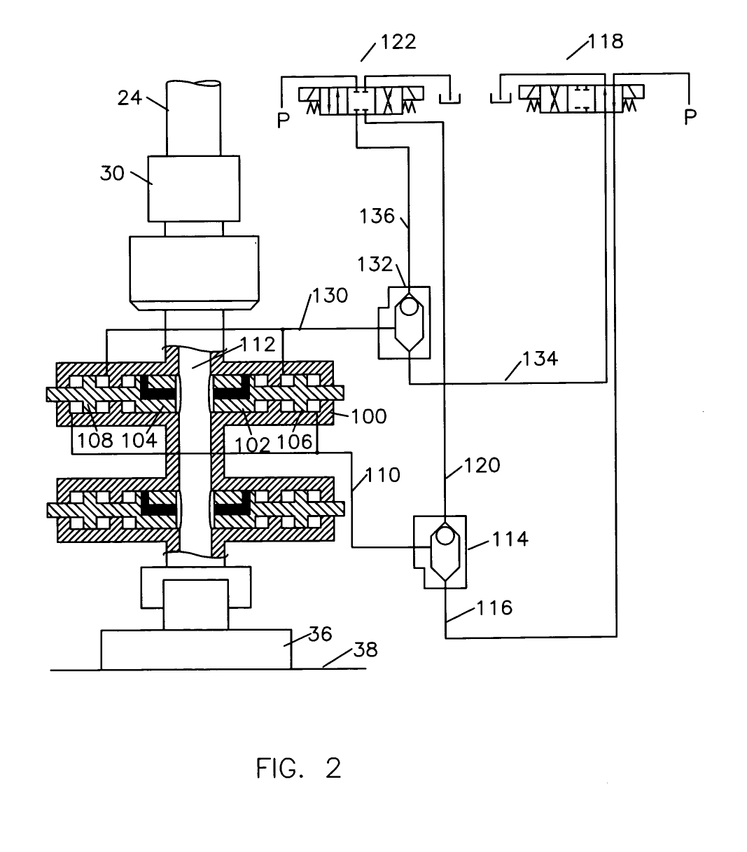

Referring now to FIG. 2, blowout preventer 100 has rams 102 and 104 which will sealingly engage each other to seal the bore. Pistons 106 and 108 are pressurized through line 110 to move them towards the bore to move the rams 102 and 104 into the bore 112. Line 110 is pressurized through line 116 from blue control pod 118 or through line 120 from yellow control pod 122. As this occurs flow from the opposite side of pistons 106 and 108 flows through line 130 to shuttle valve 132 and back to either the blue pod 118 through line 134 or the yellow pod 122 through line 136. This can be repeated for up to one hundred functions on a complex subsea drilling system.

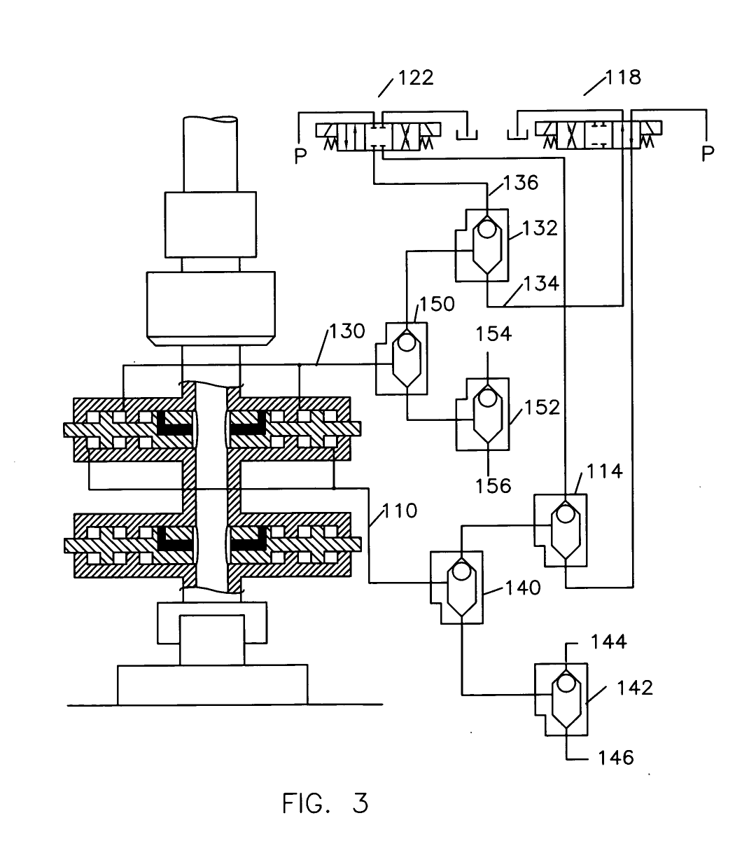

Referring now to FIG. 3, shuttle valve 114 is complimented with shuttle valves 140 and 142 in order to receive signals through line 144 from an acoustic control pod or through line 146 from an ROV. Likewise shuttle valve 132 is complimented with shuttle valves 150 and 152 in order to receive signals through line 154 from an acoustic control pod or through line 156 from an ROV. As one can imagine, if this is repeated for 100 different functions, the control systems become extremely complex.

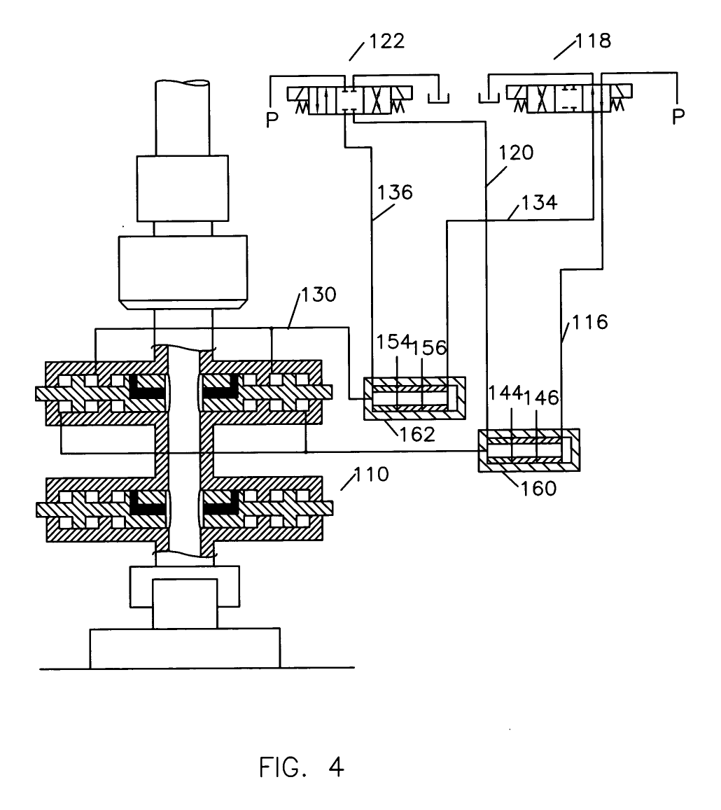

Referring now to FIG. 4, the triple shuttle valves of FIG. 3 are replaced by a single shuttle of the type of this invention. The same line designations are used to illustrate how much simpler the plumbing becomes with the use of this valve. Multi-port shuttle valve 160 has replaced shuttle valves 114, 140, and 142 along with all the associated plumbing. Multi-port shuttle valve 162 has replaced shuttle valves 132, 150, and 152 along with all the associated plumbing.

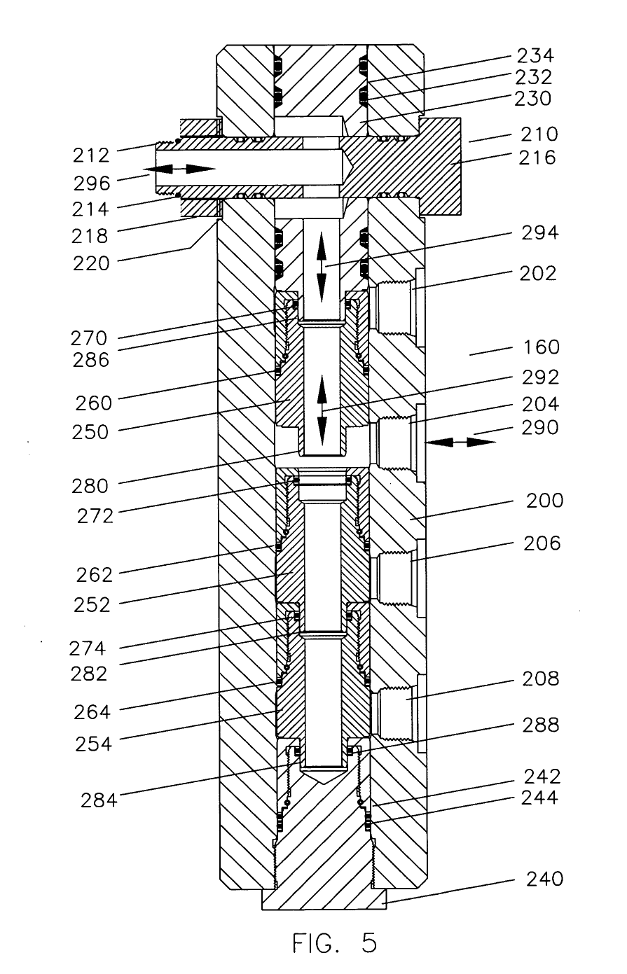

Referring now to FIG. 5, multi-port shuttle valve 160 is shown in detail. Body 200 has inlet/outlet ports 202, 204, 206, and 208. Pivot axle 210 has a thread 212 and seal 214 on one end to engage a function to be operated such as a blowout preventer. When the head 216 is turned to screw the pivot axle 210 into the desired function, the body 200 is free to be swiveled until the spacer 218 contacts the face of the object to be engaged and the spring washers 220 are preloaded. This preloading will friction lock the body 200 into a specific desired orientation so the unit will not swivel in service. End plug 230 has seals 232 which sealingly engage bore 234 of body 200 at the first end. End plug 240 has seals 244 which sealingly engage bore 242 at the second end.

Shuttles 250, 252, and 254 have seals 260, 262, and 264 respectively to seal in bore 242 of body 200 and have internal seals 270, 272, and 274 which seal against projections 280, 282, and 284 respectively. End plug 230 has projection 286 and end plug 240 has internal seal 288.

Double arrows 290, 292, 294, and 296 illustrate the flow path from the control system attached to port 204 to the operated function to which pivot axle 210 is attached.

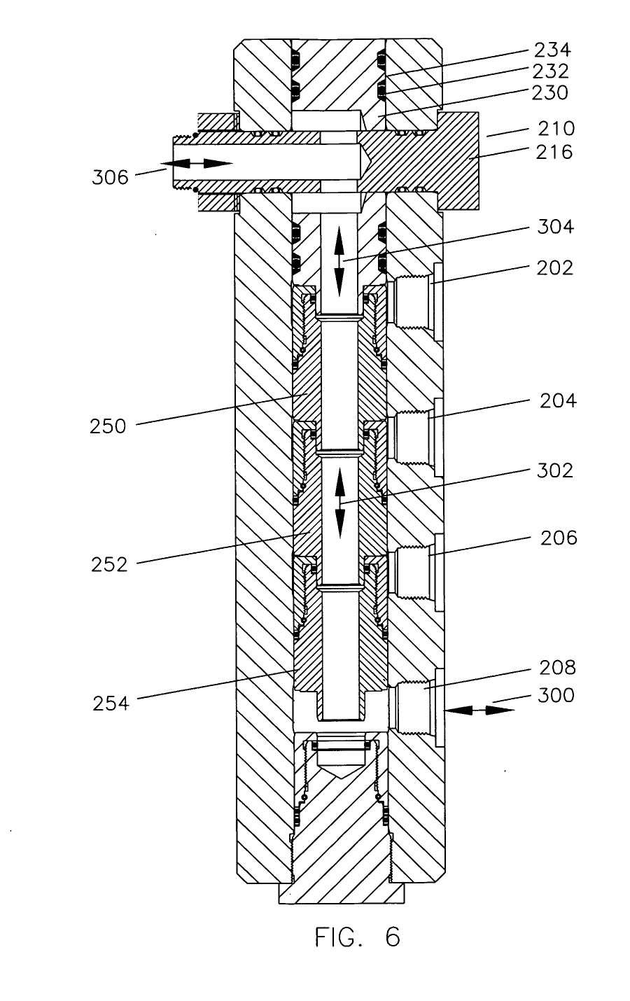

Referring now to FIG. 6, multi-port shuttle 160 has had flow input from the function attached to port 208 and shuttles 252 and 254 have been moved (upwards on the page) to allow the flow path as indicated by the double arrows 300, 302, 304, and 306. Similarly flow into ports 202, 204, or 206 will shift shuttles to appropriate positions to direct the flow appropriately.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. The method of providing a shuttle valve which will accept 3 or more inlets and a single outlet, comprising:
providing a body having a bore and an outlet,
providing two or more shuttles within said bore,
providing an inlet in said body between each of said shuttles, and
causing flow from a first inlet to move said shuttles to positions appropriate to allowing flow from said first inlet into said shuttle valve and blocking flow out of the other of said inlets.

2. The method of claim 1 further comprising said shuttles having a bore therethrough.

3. The method of claim 1, further comprising said outlet is proximate a first end.

4. The method of claim 1, further comprising said outlet is rotatably mounted relative to said body.

5. The method of claim 4, further comprising said outlet is no longer rotatably mounted relative to said body when said outlet is fully engaged with the device to which the flow is to be delivered.

6. The method of providing a shuttle valve which will accept 3 or more inputs, comprising:
providing a body having a bore and an outlet proximate a first end,
providing two or more shuttles within said bore,
providing an inlet in said body between each of said shuttles, and
flow into an inlet causing the shuttles between said inlet and a first end of said body being urged toward said first end and shuttles between said inlet the second end of said body being urged toward said second end of said body.

7. The method of claim 6 further comprising said shuttles having a bore therethrough.

8. The method of claim 6, further comprising said outlet is proximate a first end.

9. The method of claim 6, further comprising said outlet is rotatably mounted relative to said body.

10. The method of claim 9, further comprising said outlet is no longer rotatably mounted relative to said body when said outlet is fully engaged with the device to which the flow is to be delivered.
